(19) United States
(12) Patent Application Publication
(10) Pub. No.: US 2004/0205085 A1
(43) Pub. Date: Oct. 14, 2004

(54) Method of representing things using programmable systems

(76) Inventor: James R. Austin, McAllen, TX (US)

Correspondence Address: James R. Austin, 609 Heron Ave., McAllen, TX, 78504-2047, US

(21) Appl. No.: 10/364,806

(22) Filed: Apr. 14, 2003

(51) Int. Cl. G06F 7/00; G06N 5/02; G06F 17/00; G06N 5/00

(52) U.S. Cl. 707/103 R; 706/45; 707/104.1

(57) ABSTRACT

This invention provides a flexible method of representing things that is suitable for artificial intelligence applications. The method is based on creating instances of the form named _THING. The instance can be created in programmable systems. Similar to things, each instance can have various types of relationships with any number of other instances.

### CROSS-REFERENCE TO RELATED APPLICATIONS

This application is an improvement to application Ser. No. 10/194,357 titled “Creation Theory” submitted earlier by same inventor.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX:

Not Applicable

### BACKGROUND OF THE INVENTION

Representing things is a very basic yet profound operation. It is in great part our unmatched ability to represent things that makes humans so unique in this universe.

This invention resulted from research to develop a database that overcomes the current limitations to fully represent things. This invention resulted from research to develop a database that strives to approach the flexibility of the human brain to represent things.

For example, existing databases can efficiently represent uniform aspects of many similar things. The uniform aspects of these things can be readily arranged into tables. An example is the first name, last name and birth date of persons where each person is related to employer(s).

However, existing databases can't efficiently represent many common aspects of things. These aspects of things cannot be readily arranged into tables. FIG. 1 shows an example where John has various types of relationships with various numbers of other things.

In reality, each thing can be related to a variable number of other things. In addition, each relationship between things can be a different type. Representing such diverse things and their relationships in existing databases is difficult since the primary method requires that data fit into the rigid format of tables.

In this invention, each thing is represented by an instance of the form named _THING. Similar to the things being represented, each instance can be related to a variable number of other instances. Similar to the different types of relationships between the things, each instance can have different types of relationships with other instances. An example of using these instances to represent FIG. 1 is provided later.

### SUMMARY OF THE INVENTION

This invention provides a flexible method of representing things that is suitable for artificial intelligence applications. The method is based on creating instances of the form named _THING. The instance can be created in programmable systems. Similar to things, each instance can have various types of relationships with any number of other instances.

### BRIEF DESCRIPTION OF THE FIGURES

FIG. 1—Common things and relationships between them

FIG. 2—Resources of various programmable systems

FIG. 3—The form _THING

FIG. 4—A _thing at a specific instant in time

FIG. 5—Pair of reciprocal references within _things

FIG. 6—Physical, symmetrical references

FIG. 7—Non-physical, symmetrical references in RAM using unique IDs

FIG. 8—Non-physical, symmetrical references in RAM using pointers

FIG. 9—Non-symmetrical references

FIG. 10—_Things representing entities, relator and sentence

FIG. 11—Simplified figure representing entities, relator and sentence

FIG. 12—_Things to represent property and value

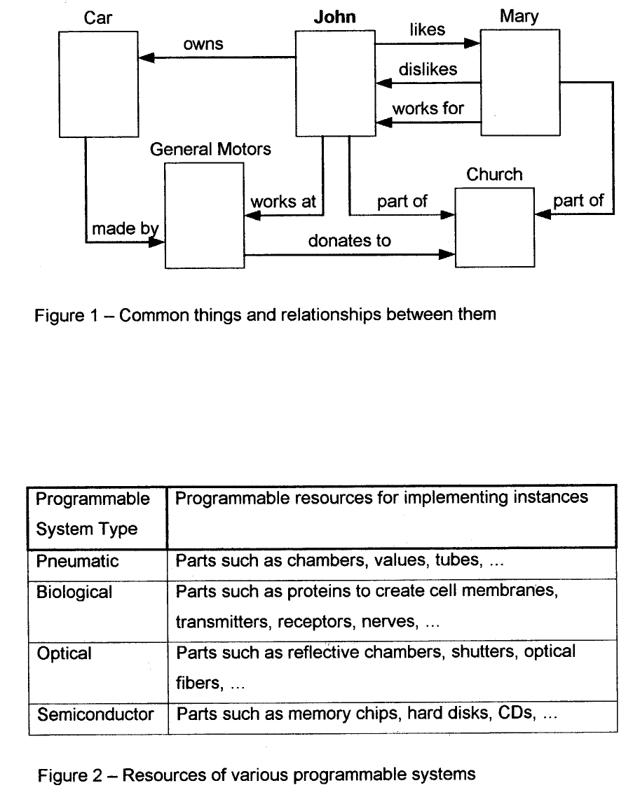

### DETAILED DESCRIPTION OF THE INVENTION

This invention provides a flexible method of representing things that is suitable for artificial intelligence applications.

This invention provides a method of representing things by creating instances of the form named _THING in programmable systems.

The best use of this invention is to create databases, programs and operating systems for artificial intelligence applications using programmable systems.

Currently, semiconductor based programmable systems are the most practical mode contemplated by the inventor for carrying out the invention.

In the future, mechanically, biologically and optically programmable systems or combinations thereof may provide practical modes for carrying out the invention.

In this invention, the words “_THING” and “_thing” are introduced. The inventor chooses to use “_THING” and “_thing” because they are closely related to common word “thing”. The common word “thing” means anything tangible or intangible. Similarly a “_thing” created in a programmable system represents anything tangible or intangible.

In this invention, the following words are also defined, some in terms of _THING or _things: programmable system, programmable resource, form, boundary, reference, entity, relator, relation, sentence, subject, verb and object.

In this invention, a programmable system is defined as any system in which instances of the form _THING can be created programmatically. The system will have some type of programmable resources where or with which the instances can be created. The system will have some type of processor for carrying out programmed steps to manipulate its programmable resources. The system will have some type of input/out capability to allow the processor to communicate things. The system will have some type of power source to fuel the computing process.

In this invention, a programmable resource is defined as anything within a system that the system processor can manipulate to create instances of the form _THING. FIG. 2 summarizes the various types of programmable resources available in different types of programmable systems for implementing instances.

In this invention, a form is defined as that which is common among instances under consideration. For example, although a planet, a basketball and a ball bearing are made of varying materials and are of varying sizes, that which is common among all of them is the form sphere.

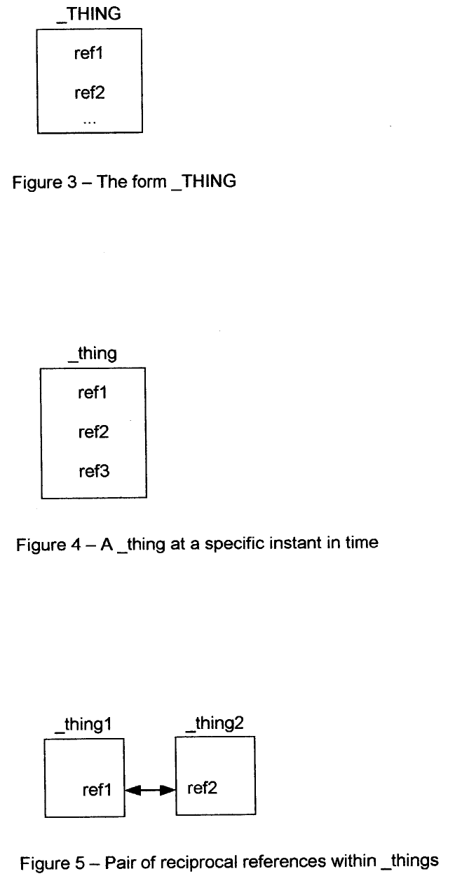

In this invention, the form _THING is defined as a boundary containing references where the number of references is variable from 0 to infinity. FIG. 3 shows the form _THING where the square box is the boundary, ref1 and ref2 are references and “ . . . ” indicates the number of references is variable.

In this invention, instances of the form named _THING are used to represent things, anything tangible or intangible. Instances of the form _THING (capitalized) are named _things (lower case).

When an instance of the form _THING is created in a system, the total number of references within an instance is variable from zero (0) to a positive integer whose maximum value is limited by the programmable resources available in the system. FIG. 4 shows a _thing at a specific instant in time when it has three references.

In this invention, a _thing's boundary is anything created by the processor using the system's programmable resources that allows the processor to determine the beginning(s) and end(s) of a thing and contain its references. Because each type of programmable system will provide different types of programmable resources, the implementation of a boundary is system dependent. For example, in a biologically programmable system, the boundary can be a spherical wall made from proteins. In a semiconductor based programmable system consisting of linearly addressable memory, the initial and terminal boundaries can be specific values such as NULL (0).

In this invention, a reference is anything within one thing created by the processor using the system's programmable resources that allows the processor to determine a reciprocal reference within another _thing. In effect, a reference within one _thing implements a “connection” to another reference within another thing. FIG. 5 shows _thing1's ref1 “connects” to _thing2's ref2.

Because each type of programmable system will provide different types of programmable resources, the implementation of a reference is system dependent. Implementation of references could be categorized as physical/non-physical, symmetrical/non-symmetrical.

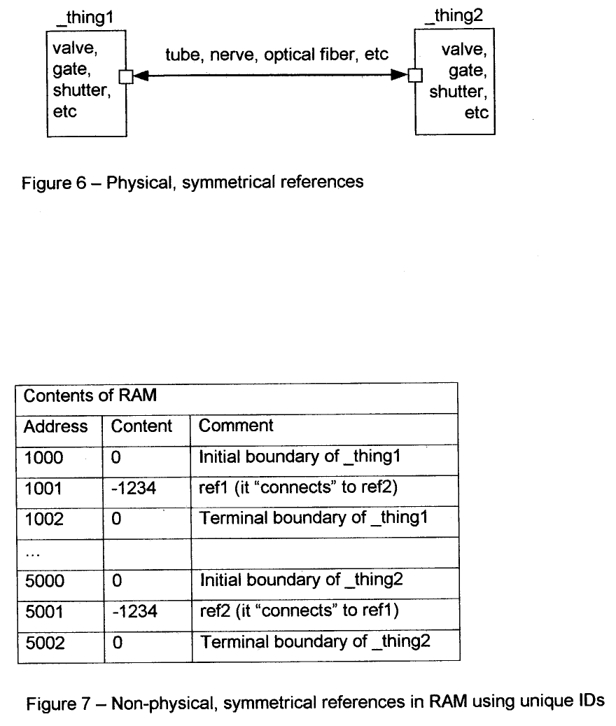

In some cases a system allows a physical, symmetrical connection between reciprocal references. For example, when this invention is implemented on a mechanical system, a reference can be a _thing's valve to a pneumatic tube that connects to another _things. When this invention is implemented on a biological system, a reference can be a thing's gate to a nerve that connects to another _thing. When this invention is implemented on an optical system, a reference can be a _thing's shutter to an optical fiber that connects to another thing. In each case, the reciprocal reference is the valve, gate or shutter at the other end of the tube, nerve or optical fiber. FIG. 6 shows possible implementations.

In other cases, a system's programmable resources allow a non-physical “connection” between reciprocal references. Semiconductor based programmable systems allow non-physical symmetrical and non-symmetrical references as discussed below.

Non-physical, symmetrical references can be implemented by storing unique IDs for each pair of reciprocal references. For example, in FIG. 7, the system processor stores −1234 in _thing1's ref1 and in _thing2's ref2. This allows the processor to “connect” the two references.

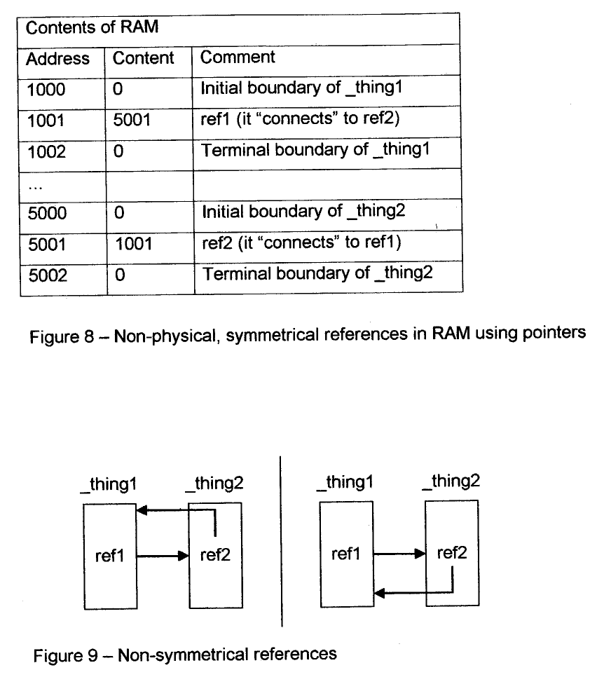

Non-physical, symmetrical references can also be implemented by storing the address of the reciprocal reference. For example, in FIG. 8, the system processor stores 5001 in _thing1's ref1 and stores 1001 in _thing2's ref2. This allows the processor to “connect” the two references. An address whose value contains the address of another is called a pointer.

References need not be symmetrical as long as they allow the processor to determine the reciprocal reference. In a pair of non-symmetrical references, one of them does not “connect” directly to the other. One of the references can “connect” to the boundary of another _thing containing the reciprocal reference. FIG. 9 shows two examples of such non-symmetrical references. In the first part of FIG. 9, ref2 “connects” to the initial boundary of thing1. In the second part of FIG. 9, ref2 “connects” to the terminal boundary of thing1.

In this invention, when a relation (defined later) is formed between _things, the system processor adds reference(s) to each related _thing. The programming steps are described and demonstrated later.

In the example given later, the programmable system is a Personal Computer (PC) where the processor is the Central Processing Unit (CPU), the resource where instances are created is random access memory (RAM) and non-physical, non-symmetrical, pointer based references are used as to simplify implementation.

Notation for _things:

Let “[ ]” note a boundary within a system where _things are created.

Let letter(s) and/or number(s) (i.e. t1, t2, t3) note the name of a _thing.

Let “=” note that the name (i.e. t1, t2, t3) to its left is equivalent to the _thing to its right.

Let “{ }” note a _thing's boundary.

Let “ref1→ref2” note a reference where the name before the arrow is the reference's name and the name after the arrow is what the reference “connects” to.

Let space separate references within a _thing.

Let “ . . . ” note that the prior pattern may continue.

Using the above notation, the general form of a _thing within a system is defined as:

[t1={ref1→ref2 refX→refY . . . }]

where the number of references is variable.

In the above notation “t1=” does not exist within the boundaries (“[ ]”) It is only shown to make it easier to refer to _thing “{ref1→ref2 refX→refY . . . }”. Also the reference names before and after the “→” do not exist within the boundaries (“{ }”). They are only shown to make it easier to identify the reference and what it “connects” to.

A system's processor executes the following steps to create a new thing to represent a thing:

a) Specify a list of existing _things, if any, that are related to the new _thing. If the new _thing is to represent an entity or relator, no existing _things need to be specified. If the new _thing is to represent a sentence containing relation(s), at least two existing _things that represent entities and one existing _thing that represents a relator need to be specified.

b) Allocate at minimum sufficient programmable system resources to define the boundaries of the new _thing and create reference(s) to specified list of existing _things. In a biologically programmable system, the resources can be proteins. In a pneumatically programmable system, the resources can be chambers, valves and tubes. In an optically programmable system, the resources can be optical cells, shutters and fibers optics. In semiconductor-based programmable systems, the resources can be bits of memory or sectors/tracks on a hard drive.

c) Within the allocated programmable system resources, define the initial boundary(s) of the new _thing. Optionally, define the terminal boundary(s) of the new _thing. The new _thing may or may not utilize all of the allocated resources. In biologically programmable systems, the system processor can manipulate proteins to define a cell membrane. In pneumatically programmable systems, the boundary can be the walls of a pressure chamber. In optically programmable systems, the boundary can be an enclosure whose interior surface is reflective. In semiconductor-based programmable systems, the initial and terminal boundaries of the _thing can be NULL (0) values in RAM or on a hard drive.

d) For each existing _thing specified in the list, create a reference within the new _thing and add a reciprocal reference within the specified existing _thing such that given either reference the system processor is able to determine the other. If required, update the boundary(s) of the existing instance to accommodate the additional reference. In pneumatically programmable systems, this can be accomplished by connecting a tube between two _things. In biologically programmable systems, this can be accomplished by connecting a nerve between two _things. In optically programmable systems, this can be accomplished by connecting an optical fiber between two _things. In semiconductor-based programmable systems, this can be accomplished by “connecting” two memory addresses.

e) Within the allocated programmable system resources, define the terminal boundary(s) of the new _thing, if not already done so earlier.

The above steps when implemented on a PC using C programming language are shown later in the functions _Thing_Create( ) and _Thing_AddReference( ).

The remaining sections demonstrate how things can be used to represent various kinds of things.

_Things can be created to represent: entities and sentences. Examples of entities are “John” and “Mary”. Entities represent anything except for relationships between things. A subcategory of entity is relator. A relator represents a relationship type. Examples of relators are “likes” and “dislikes”. A relation is a relationship between two entities where the relationship type is indicated by a relator. An example of a relation is “John likes Mary”. A sentence contains one or more relations. The relation “John likes Mary” and the relation “John likes Sue” can be expressed in one sentence as “John likes Mary Sue” and this process can be extended. A sentence is represented by a _thing. The first _thing referenced in a sentence is designated as the subject. The second _thing referenced in a sentence is designated as the verb. The remaining _things referenced in a sentence are designated as objects. A sentence must reference one subject, one verb and one or more objects.

The following are general steps to represent entities, relators and sentences using _things:

1) Create a _thing to represent each entity (i.e. John, Mary). When a _thing to represent an entity is created, no other _things need to be specified.

2) Create a thing to represent each relator (i.e. likes, dislikes). When a _thing to represent a relator is created, no other things need to be specified.

3) Create a _thing to represent each sentence. A sentence contains one or more relations. A relation contains, at minimum, two entities and a relator. The appropriate entities and relator need to be specified in the proper order when creating a _thing to represent the desired sentence. For example, to create a _thing to represent the sentence containing the relation “John likes Mary”, _things “John”, “likes” and “Mary” need to be specified in that order. To create a _thing to represent a sentence containing the relations “John likes Mary” and “John likes Sue”, _things “John”, “likes”, “Mary” and “Sue” need to be specified in that order.

Below is an example of creating _things to represent entity “John”, relator “likes”, entity “Mary”, and the sentence containing the relation “John likes Mary”. At each step, the state of the system where _things are created is shown on the following line within square brackets (“[ ]”).

Create a _thing to represent entity “John”:

[John={ }]

Create a _thing to represent relator “likes”:

[John={ } likes={ }]

Create a _thing to represent entity “Mary”:

[John={ } likes={ } Mary={ }]

Create a _thing to represent the sentence containing the relation “John likes Mary” (named s1):

[John={2→1} likes={4→3} Mary={6→5} s1={1→2, 3→4, 5→6}]

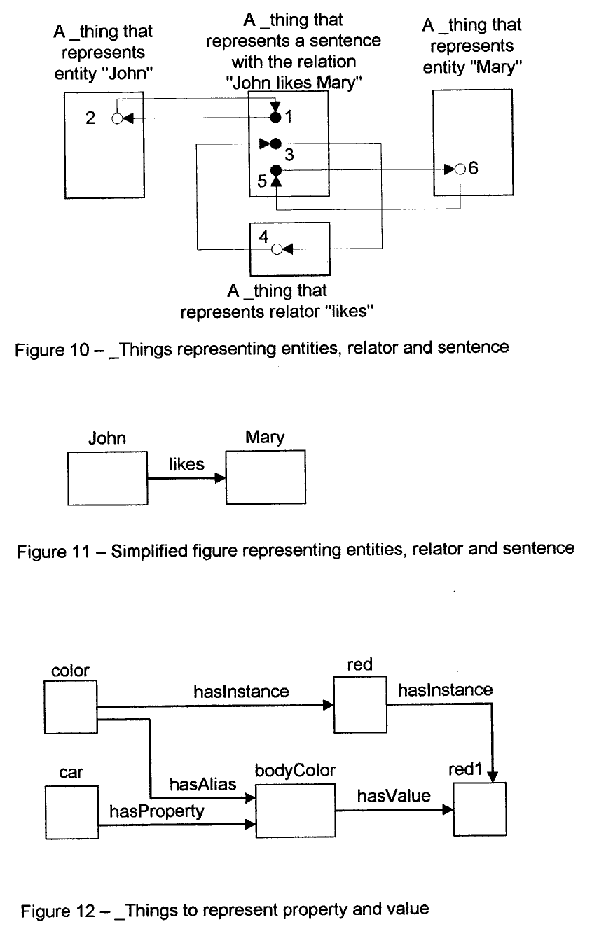

As noted earlier, “John=”, “likes=”, “Mary=”, “s1=”, “1”, “2”, “3”, “4”, “5” and “6” are not within the boundaries (“[ ]”). They are shown only to make it easier to refer to _things and references. FIG. 10 shows the same system graphically.

FIG. 10 can be simplified to FIG. 11 to allow more complex figures. In FIG. 11, the word and line between the _things imply the relator “likes” and the sentence containing the relation “John likes Mary”. The sentence is read in the direction of the arrow.

The above steps of creating entities, relators and sentences containing relations when implemented on a PC using C programming language are shown later in the function Demo( ).

The following are general steps to represent common class/instance relationships:

1) Create a _thing to represent the entity that is the class of instances.

2) Create a _thing to represent the relator “hasInstance” or similar.

3) Create a _thing to represent the entity that is an instance of the class.

4) Create a _thing to represent a sentence containing the relation between class and instance.

An example of the above steps is shown below.

Create a _thing to represent entity “person”:

[person={ }]

Create a _thing to represent relator “hasInstance”:

[person={ } hasInstance={ }]

Create a _thing to represent entity “John”:

[person={ } hasInstance={ } John={ }]

Create a _thing to represent sentence containing the relation “person hasInstance John” (s1):

[person={2→1} hasInstance={4→3} John={6→5} s1={1→2 3→4 5→6}]

Create a _thing to represent entity “Mary”:

[person={2→1} hasInstance={4→3} John={6→5} s1={1→2 3→4 5→6} Mary={ }]

Create a _thing to represent sentence containing the relation “person hasInstance Mary” (s2):

[person={2→1 8→7} hasInstance={4→3 10→9} John={6→5} s1={1→2 3→4 5→6} Mary={12→11} s2={7→8 9→10 11→12}]

The relations “person hasInstance John” and “person hasInstance Mary” can be simplified to “person hasInstance John Mary” (s3) and could be extended to include more instances:

[person={2→1} hasInstance={4→3} John={6→5} Mary={8→7} s3={1→2 3→4 5→6 7→8}]

The above process of creating class/instance relationships is shown later in function Demo( ).

The following are general steps to represent common composite/part relationships:

1) Create a _thing to represent the entity that is the composite of parts.

2) Create a _thing to represent the relator “hasPart” or similar.

3) Create a _thing to represent the entity that is a part of the composite.

4) Create a thing to represent a sentence containing the relation between composite and part.

An example of the above steps is shown below.

Create a _thing to represent entity “church”:

[church={ }]

Create a _thing to represent relator “hasPart”:

[church={ } hasPart={ }]

Create a _thing to represent entity “John”:

[church={ } hasPart={ } John={ }]

Create a _thing to represent sentence containing the relation “church hasPart John” (s1):

[church={2→1} hasPart={4→3} John={6→5} s1={1→2 3→4 5→6}]

Create a _thing to represent entity “Mary”:

[church={2→1} hasPart={4→3} John={6→5} s1={1→2 3→4 5→6} Mary={ }]

Create a _thing to represent sentence containing the relation “church hasPart Mary” (s2):

[church={2→1 8→7} hasPart={4→3 10→9} John={6→5} s1={1→2 3→4 5→6} Mary={12→11} s2={7→8 9→10 11→12}]

The relations “church hasPart John” and “church hasPart Mary” can be simplified to “church hasPart John Mary” (s3) and could be extended to include more parts:

[church={2→1} hasPart={4→3} John={6→5} Mary={8→7} s3={1→2 3→4 5→6 7→8}]

The above process of creating composite/part relationships is shown later in function Demo( ).

The following are general steps to represent properties and values. These steps allow a _thing to have any number of properties. These steps allow a property to have any number of values. A property is represented by a _thing that has the relationship of being a property of another _thing. A value is represented by a _thing that has the relationship of being a value of another thing. Since properties and values are represented by _things, they themselves can have properties and values.

In general a _thing (t1) can have one of more properties (t2). A property (t2) can have one or more values (t3). The property is an alias of a class (t4) whose instances (t5) are related to the value (t3). The property's (t2) class's (t4) instances (t5) determine the range of the value (t3). The _things to represent property and value are listed below and shown in FIG. 12.

1) Car (t1) hasProperty bodyColor (t2).

2) BodyColor (t2) hasValue red1 (t3).

3) Color (t4) hasAlias bodyColor (t2).

4) Color. (t4) hasInstance red (t5).

5) Red (t5) hasInstance red1 (t3).

As shown if FIG. 12, since a property (bodyColor) and its value (red1) are _things, either can have its own properties. For example, if the value was a number, we can attach a unit of measure property and its value might be kilograms.

The above process of creating property and value is shown later in function Demo( ).

Although implementation of the invention is not limited to semiconductor-based programmable systems, it is demonstrated below on a PC using the standard C programming language.

1) I claim the method of representing things (anything tangible or intangible) by creating instances of the form named _THING ([03100]) in programmable systems ([03070]) using the following steps:
a) Specify a list of existing instances, if any, that are related to the new instance.
b) Allocate at minimum sufficient programmable system resources ([03080]) to define the boundaries ([03130]) of the new instance and create reference(s) ([03140]) to specified list of existing instances.
c) Within the allocated programmable system resources, define the initial boundary(s) of the new instance. Optionally, define the terminal boundary(s) of the new instance.
d) For each existing instance specified in the list, create a reference within the new instance and add a reciprocal reference within the specified existing instance such that given either reference the system processor is able to determine the other. If required, update the boundary(s) of the existing instance to accommodate the additional reference.
e) Within the allocated programmable system resources, define the terminal boundary(s) of the new instance, if not already done so earlier.
